(19) United States
(12) Patent Application Publication
(10) Pub. No.: US 2026/0263933 A1
(43) Pub. Date: Sep. 10, 2026

(54) AVATAR ACTIONS AND BEHAVIORS IN VIRTUAL ENVIRONMENTS

(71) Applicant: InterDigital CE Patent Holdings, SAS, Paris (FR)

(72) Inventors: João Pedro COVA REGATEIRO, Chateaubourg (FR); Quentin AVRIL, BETTON (FR); Patrice HIRTZLIN, Betton (FR); Philippe GUILLOTEL, VERN SUR SEICHE (FR)

(21) Appl. No.: 19/167,311

(22) PCT Filed: Mar. 15, 2024
(86) PCT No.: PCT/EP2024/057089

§ 371 Date: Sep. 19, 2025

(30) Foreign Application Priority Data
Mar. 24, 2023 (EP) 23305404.8
Apr. 19, 2023 (EP) 23305602.7

(51) Int. Cl. A63F 13/55

(52) U.S. Cl. CPC A63F 13/55

(57) ABSTRACT

In one implementation, a new set of actions and behaviors associated with interactive spaces and avatars in 3D virtual environments are proposed. These actions and behaviors define the capabilities of an avatar in areas of interactivity. They can be used in MPEG-I Scene Description to support avatar social interactivity in 3D environments with corresponding time-based events. Generally, capabilities describe the allowed actions of an avatar following a trigger event in a region of interactivity. In the case “Disabilities” are defined for the user, information included in “Disabilities” will also impact the capabilities of a user avatar. The actions, for example, can include social action, restriction action, parental action, speech action, capabilities action and disabilities action. In one example, a new type of property (ACTION_SET_AVATAR) is included to the framework of MPEG_scene_activity. Under ACTION_SET_AVATAR, an object (avatarAction) is used to represent avatar-specific actions.

### TECHNICAL FIELD

The present embodiments generally relate to digital human interaction within 3D virtual scenes, more particularly, to avatar actions and behaviors in virtual environments.

### BACKGROUND

Extended reality (XR) is a technology enabling interactive experiences where the real-world environment and/or a video content is enhanced by virtual content, which can be defined across multiple sensory modalities, including visual, auditory, haptic, etc. During runtime of the application, the virtual content (3D content or audio/video file for example) is rendered in real-time in a way that is consistent with the user context (environment, point of view, device, etc.). Scene graphs (such as the one proposed by Khronos/glTF (Graphics Language Transmission Format) and its extensions defined in MPEG Scene Description format or Apple/USDZ for instance) are a possible way to represent the content to be rendered. They combine a declarative description of the scene structure linking real-environment objects and virtual objects on one hand, and binary representations of the virtual content on the other hand. Scene description frameworks ensure that the timed media and the corresponding relevant virtual content are available at any time during the rendering of the application. Scene descriptions can also carry data at scene level describing how a user can interact with the scene objects at runtime for immersive XR experiences.

### SUMMARY

According to one embodiment, a method is provided, comprising: obtaining, from a description for an extended reality scene, at least a parameter used to define one or more permitted actions for an avatar node representing an avatar; activating a trigger to an action associated with said avatar node, wherein said action belongs to said one or more permitted actions; and launching said action for said avatar node.

According to another embodiment, a method is provided, comprising: generating at least a parameter in a description for an extended reality scene to define one or more permitted actions for an avatar node representing an avatar; associating a trigger to an action with said avatar node, wherein said action belongs to said one or more permitted actions; and encoding said description for said extended reality scene.

According to another embodiment, an apparatus is provided, comprising one or more processors and at least one memory, wherein said one or more processors are configured to: obtain, from a description for an extended reality scene, at least a parameter used to define one or more permitted actions for an avatar node representing an avatar; activate a trigger to an action associated with said avatar node, wherein said action belongs to said one or more permitted actions; and launch said action for said avatar node.

According to another embodiment, an apparatus is provided, comprising one or more processors and at least one memory, wherein said one or more processors are configured to: generate at least a parameter in a description for an extended reality scene to define one or more permitted actions for an avatar node representing an avatar; associate a trigger to an action with said avatar node, wherein said action belongs to said one or more permitted actions; and encode said description for said extended reality scene.

One or more embodiments also provide a computer program comprising instructions which when executed by one or more processors cause the one or more processors to perform the method according to any of the embodiments described herein. One or more of the present embodiments also provide a computer readable storage medium having stored thereon instructions for processing scene description according to the methods described herein.

One or more embodiments also provide a computer readable storage medium having stored thereon scene description generated according to the methods described above. One or more embodiments also provide a method and apparatus for transmitting or receiving the scene generation generated according to the methods described herein.

### BRIEF DESCRIPTION OF THE DRAWINGS

FIG. 1 shows an example architecture of an XR processing engine.

FIG. 2 shows an example of the syntax of a data stream encoding an extended reality scene description.

FIG. 3 shows an example graph of an extended reality scene description.

FIG. 4 shows an example of an extended reality scene description comprising behavior data.

FIG. 5 illustrates an example of the execution of a hierarchical action, according to an embodiment.

FIG. 6 illustrates the generation of parameters with scene encoding.

FIG. 7 illustrates a diagram of the encoder, according to an embodiment.

### DETAILED DESCRIPTION

Various XR applications may apply to different context and real or virtual environments. For example, in an industrial XR application, a virtual 3D content item (e.g., a piece A of an engine) is displayed when a reference object (piece B of an engine) is detected in the real environment by a camera rigged on a head mounted display device. The 3D content item is positioned in the real-world with a position and a scale defined relatively to the detected reference object.

For example, in an XR application for interior design, a 3D model of a furniture is displayed when a given image from the catalog is detected in the input camera view. The 3D content is positioned in the real-world with a position and scale defined relatively to the detected reference image. In another application, some audio file might start playing when the user enters an area close to a church (being real or virtually rendered in the extended real environment). In another example, an ad jingle file may be played when the user sees a can of a given soda in the real environment. In an outdoor gaming application, various virtual characters may appear, depending on the semantics of the scenery which is observed by the user. For example, bird characters are suitable for trees, so if the sensors of the XR device detect real objects described by a semantic label ‘tree’, birds can be added flying around the trees. In a companion application implemented by smart glasses, a car noise may be launched in the user's headset when a car is detected within the field of view of the user camera, in order to warn him of the potential danger. Furthermore, the sound may be spatialized in order to make it arrive from the direction where the car was detected.

An XR application may also augment a video content rather than a real environment. The video is displayed on a rendering device and virtual objects described in the node tree are overlaid when timed events are detected in the video. In such a context, the node tree comprises only virtual objects descriptions.

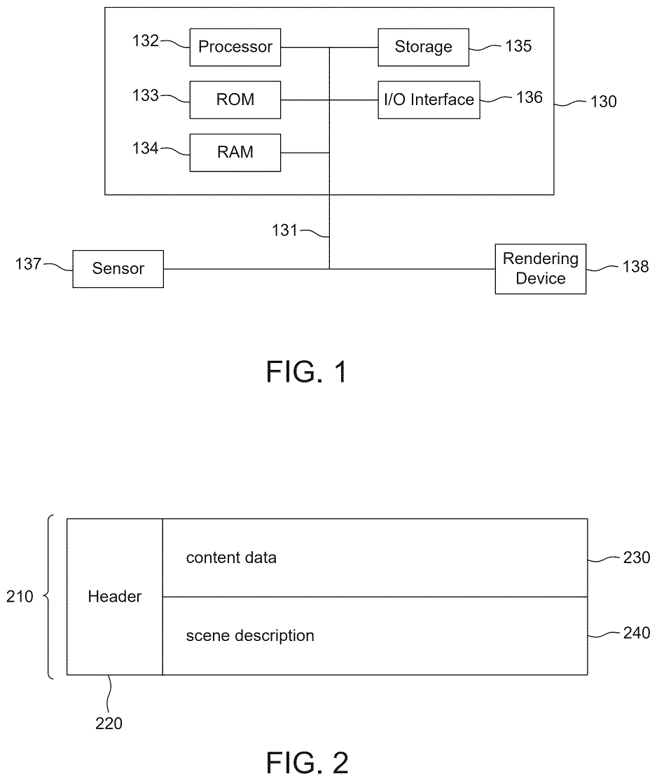

FIG. 1 shows an example architecture of an XR processing engine 130 which may be configured to implement the methods described herein. A device according to the architecture of FIG. 1 is linked with other devices via their bus 131 and/or via I/O interface 136.

Device 130 comprises following elements that are linked together by a data and address bus 131:
a microprocessor 132 (or CPU), which is, for example, a DSP (or Digital Signal Processor);
a ROM (or Read Only Memory) 133;
a RAM (or Random Access Memory) 134;
a storage interface 135;
an I/O interface 136 for reception of data to transmit, from an application; and
a power supply (not represented in FIG. 1), e.g., a battery.

In accordance with an example, the power supply is external to the device. In each of mentioned memory, the word “register” used in the specification may correspond to area of small capacity (some bits) or to very large area (e.g., a whole program or large amount of received or decoded data). The ROM 133 comprises at least a program and parameters. The ROM 133 may store algorithms and instructions to perform techniques in accordance with present principles. When switched on, the CPU 132 uploads the program in the RAM and executes the corresponding instructions.

The RAM 134 comprises, in a register, the program executed by the CPU 132 and uploaded after switch-on of the device 130, input data in a register, intermediate data in different states of the method in a register, and other variables used for the execution of the method in a register.

Device 130 is linked, for example via bus 131 to a set of sensors 137 and to a set of rendering devices 138. Sensors 137 may be, for example, cameras, microphones, temperature sensors, Inertial Measurement Units, GPS, hygrometry sensors, IR or UV light sensors or wind sensors. Rendering devices 138 may be, for example, displays, speakers, vibrators, heat, fan, etc.

In accordance with examples, the device 130 is configured to implement a method according to the present principles, and belongs to a set comprising:
a mobile device;
a communication device;
a game device;
a tablet (or tablet computer);
a laptop;
a still picture camera;
a video camera.

In XR applications, scene description is used to combine explicit and easy-to-parse description of a scene structure and some binary representations of media content. FIG. 2 shows an example of the syntax of a data stream encoding an extended reality scene description. FIG. 2 shows an example structure 210 of an XR scene description. The structure consists in a container which organizes the stream in independent elements of syntax. The structure may comprise a header part 220 which is a set of data common to every syntax element of the stream. For example, the header part comprises some of metadata about syntax elements, describing the nature and the role of each of them. The structure also comprises a payload comprising an element of syntax 230 and an element of syntax 240. Syntax element 230 comprises data representative of the media content items described in the nodes of the scene graph related to virtual elements. Images, meshes and other raw data may have been compressed according to a compression method. Element of syntax 240 is a part of the payload of the data stream and comprises data encoding the scene description as described according to the present principles.

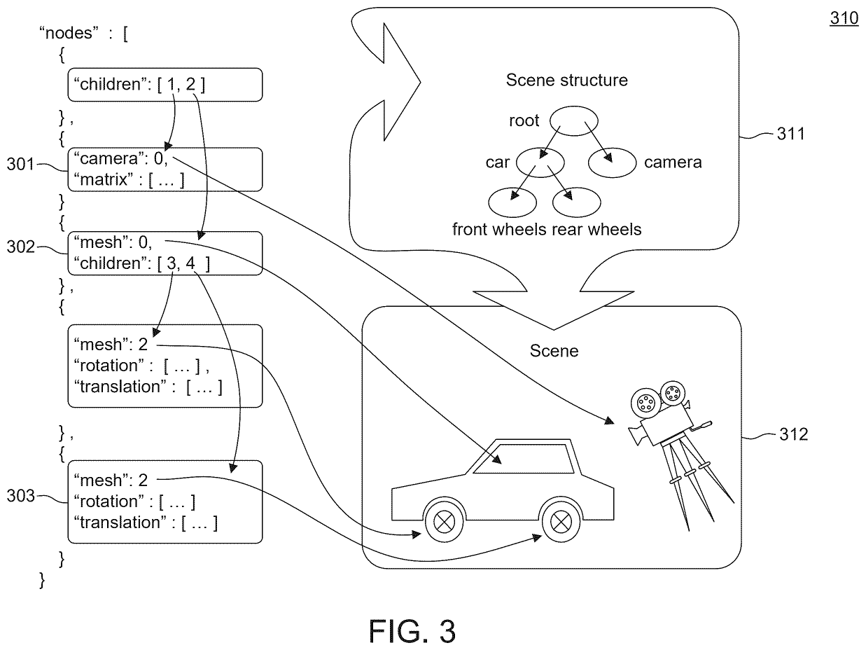

FIG. 3 shows an example graph 310 of an extended reality scene description. In this example, the scene graph may comprise a description of real objects, for example ‘plane horizontal surface’ (that can be a table or a road) and a description of virtual objects 312, for example an animation of a car. Scene description is organized as an array of nodes. A node can be linked to child nodes to form a scene structure 311. A node can carry a description of a real object (e.g., a semantic description) or a description of a virtual object. In the example of FIG. 3, node 301 describes a virtual camera located in the 3D volume of the XR application. Node 302 describes a virtual car and comprises an index of a representation of the car, for example an index in an array of 3D meshes. Node 303 is a child of node 302 and comprises a description of one wheel of the car. The same way, it comprises an index to the 3D mesh of the wheel. The same 3D mesh may be used for several objects in the 3D scene as the scale, location and orientation of objects are described in the scene nodes. Scene graph 310 also comprises nodes that are a description of the spatial relation between the real objects and the virtual objects.

In time-based media streaming, the scene description itself can be time-evolving to provide the relevant virtual content for each sequence of a media stream. For instance, for advertising purpose, a virtual bottle can be displayed on a table during a video sequence where people are seated around the table. This kind of behavior can be achieved by relying on the framework defined in the Scene Description for MPEG media document.

Currently, the MPEG-I Scene Description framework uses “behavior” data to augment the time-evolving scene description and provides description of how a user can interact with the scene objects at runtime for immersive XR experiences. These behaviors are related to pre-defined virtual objects on which runtime interactivity is allowed for user specific XR experiences. These behaviors are also time-evolving and are updated through the existing scene description update mechanism.

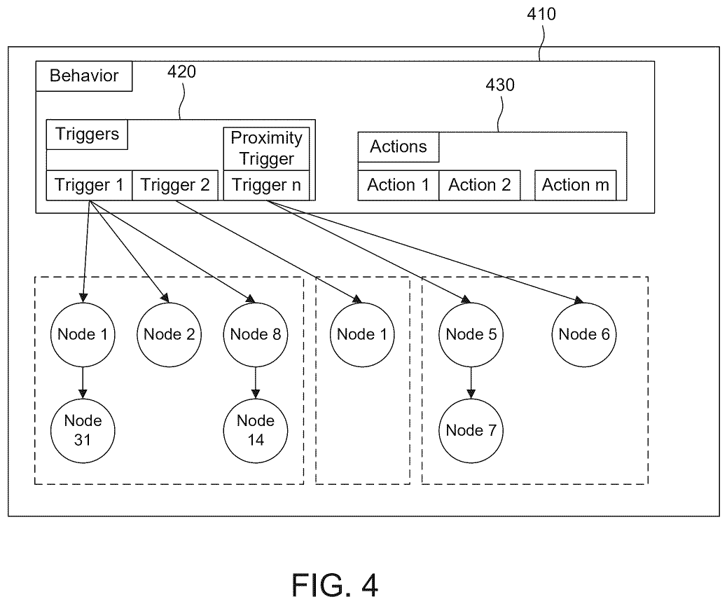

FIG. 4 shows an example of an extended reality scene description comprising behavior data, stored at scene level, describing how a user can interact with the scene objects, described at node level, at runtime for immersive XR experiences. When the XR application is started, media content items (e.g., meshes of virtual objects visible from the camera) are loaded, rendered and buffered to be displayed when triggered. For example, when a plane surface is detected in the real environment by sensors, the application displays the buffered media content item as described in related scene nodes. The timing is managed by the application according to features detected in the real environment and to the timing of the animation. A node of a scene graph may also comprise no description and only play a role of a parent for child nodes. FIG. 4 shows relationships between behaviors that are comprised in the scene description at the scene level and nodes that are components of the scene graph. Behaviors 410 are related to pre-defined virtual objects on which runtime interactivity is allowed for user specific XR experiences. Behavior 410 is also time-evolving and is updated through the scene description update mechanism.

A behavior comprises:
triggers 420 defining the conditions to be met for its activation;
a trigger control parameter defining logical operations between the defined triggers;
actions 430 to be proceeded processed when the triggers are activated;
an action control parameter defining the order of execution of the related actions;
a priority number enabling the selection of the behavior of highest priority in the case of competition between several behaviors on the same virtual object at the same time;
an optional interrupt action that specifies how to terminate this behavior when it is no longer defined in a newly received scene update; for instance, a behavior is no longer defined if a related object does not belong to the new scene or if the behavior is no longer relevant for this current media (e.g., audio or video) sequence.

Behavior 410 takes place at scene level. A trigger is linked to nodes and to the nodes' child nodes. In the example of FIG. 4, Trigger 1 is linked to nodes 1, 2 and 8. As Node 31 is a child of node 1, Trigger 1 is linked to node 31. Trigger 1 is also linked to node 14 as a child of node 8. Trigger 2 is linked to node 1. Indeed, a same node may be linked to several triggers. Trigger n is linked to nodes 5, 6 and 7. A behavior may comprise several triggers. For instance, a first behavior may be activated by trigger 1 AND trigger 2, AND being the trigger control parameter of the first behavior. A behavior may have several actions. For instance, the first behavior may perform Action m first and, then action 1, “first and then” being the action control parameter of the first behavior. A second behavior may be activated by trigger n and perform action 1 first and, then action 2, for example.

Different formats can be used to represent the node tree. For example, the MPEG-I Scene Description framework using the Khronos glTF extension mechanism may be used for the node tree. In this example, an interactivity extension may apply at the glTF scene level and is called MPEG_scene_interactivity. The corresponding semantic is provided in Table 1, where ‘M’ in ‘Usage’ column indicates that the field is mandatory in a XR scene description format and ‘O’ indicates the field is optional.

TABLE 1

| Name | Type | Usage | Description |
|---|---|---|---|
| triggers | Array | M | Contains the definition of all the triggers used in that scene. |
| actions | Array | M | Contains the definition of all the actions used in that scene. |
| behaviors | Array | M | Contains the definition of all the behaviors used in that scene. A |
| | | | behavior is composed of a pair of (triggers, actions), control |
| | | | parameters of triggers and actions, a priority weight and an |
| | | | optional interrupt action. |

In this document, we introduce a new set of actions, for example, for MPEG-I Scene Description, to support avatar social interactivity in 3D environments with corresponding time-based events. These actions are to be triggered from events between 3D objects in a virtual environment, such as, dynamic objects (humanoid and non-humanoid characters, cars, airplanes), or static objects (chairs, tables, plates). The current interactivity descriptions at the scene level only support generic actions for a node in the scene, as illustrated in Table 2. However, they do not provide an avatar node with semantical information of human social behaviors, which is a common attribute in the avatar and real-life users' description, for example, the act of walking is semantically described as “walking” or the ability to “walk” and not as a chain transformation of matrices that described the act of walking. At a higher-level, it is better and more human readable to describe actions with semantical information other than low-level computer readable 4×4 matrix multiplications. Therefore, this document presents high-level descriptions of actions that may have great impact in the 3D social and interactive environments.

TABLE 2
Action types available in MPEG_scene_interactivity

| Action type | Description |
|---|---|
| “ACTION_ACTIVATE” | Set activation status of a node |
| “ACTION_TRANSFORM” | Set transform to a node |
| “ACTION_BLOCK” | Block the transform of a node |
| “ACTION_ANIMATION” | Select and control an animation |
| “ACTION_MEDIA” | Select and control a media |
| “ACTION_MANIPULATE” | Select a manipulate action |
| “ACTION_SET_MATERIAL” | Set new material to nodes |
| “ACTION_SET_HAPTIC” | Get haptic feedbacks on a set of nodes |

The proposed representation of user capabilities is intended to be compatible with scene description (SD) content and is mainly focused on the action and behavioral representation of an avatar in interactive regions. In the following, we provide the details on the elements with the associated meaning, JSON (JavaScript Object Notation) coding schemes and how they can be used within the MPEG-I SD.

In the current description, the proposed format follows the glTF format and is compatible with the current MPEG effort to extend glTF with MPEG extensions. However, the meaning and use are generic and can be coded with any other formats, for example, XML and USD.

### Capabilities

Here we introduce the available actions and behaviors an avatar can perform within an interactive region represented as a geometric primitive. The interactive region surrounding an avatar can indicate what actions such an avatar or 3D scene object is capable of performing, hence the definition of capabilities in the context of this document. As described before, behaviors are a set of conditions that will pair triggered events with specific actions and define temporal constraints of such conditions, allowing time-based events to occur in 3D virtual environments.

### Avatar Capability

Here we introduce an illustrative example of capabilities associated with regions of interactivity in the context of social interactions between avatars and 3D objects in 3D virtual environments.

Generally, capabilities describe the allowed actions of an avatar following a trigger event in a region of interactivity. For example, in a meeting room the spectating avatars are only allowed to use speech, and upper body motion, such as, gestures and head motions, or actions that describe the abilities of the avatar (e.g., ability to run, walk, jump, talk, fly). In the case “Disabilities” are defined for the user, information included in “Disabilities” will also impact the capabilities of a user avatar.

The following lists a few non-limiting examples of actions associated to an avatar in social environments.
Social action corresponds to the social behavior of the user. It can be generic (default conversation and interactivity allowed), or user defined and specific. When interacting with another user, if a trigger is detected within an interactive region (given by the proximity or collision triggers), this region is designated for social interactions, so it will permit for instance conversation between avatars users.
Restricted action. In a scenario where permissions are required, for example, for reasons such as age, restrictions, access rights, the allowed displacement of a user can be limited. This action can also be used to limit the space the avatar is allowed to move in.
Parental action. This can limit the interaction with allowed content to protect children and young adults.
Speech action. This type of capabilities can be restricted to triggered events that only allow speech actions to be performed, e.g., in a meeting room the spectating avatars are only allowed to use speech. This action will allow the use of a microphone or a pre-recorded media track. This action can be used in combination with the social action which gives permission to certain types of interactivity, such as speech.
Capabilities action. This action lists the types of capabilities permitted for avatars or 3D objects when in contact with a region that activates the actions. The different types of capabilities should cover different types of activities, for example, but not limited to walk, fly, drive, talk. Such list of actions will notify the engine and can be combined with other action modules, such as “Action_set_haptics” to enable haptic feedback, or “Action_manipulate” to grasp objects. The objective is to create an action modifier that will restrict the animation of an avatar to the provided capabilities action list.
Disabilities action. The disabilities have the same effect as the capabilities, although it is designed to inform the engine of the user disabilities, and consequently depending on user choice it will impact the capabilities action list. This informative list is important to adapt individual user needs to the virtual environment. For example, hearing impaired users should have visual cues instead of audio cues.

All provided actions can be used in combination with existing and newly introduced actions, if permitted, and can make use of existing interactive and animation tools of different fields, for example, using manipulators to perform a “walk” motion, use of haptic manipulators to infer haptic-feedbacks or sound/media track for pre-recorded speech.

### Avatar Behavior

Behavior is a set of parameters that defines the matching between actions and trigger events. This will couple the newly defined actions with collision, proximity or user input triggers with a time-based event. The time-based behavior allows an interactivity region to have temporary actions and schedule actions depending on the desired activity.

### Time-Based Actions

Similar to time-based behavior, each action can define its own timespan. This facilitates the individual definition of time for each action at the action level instead of at the behavior level.

### Avatar Action and Behaviour Standards

In the following, we use MPEG-I as an example to illustrate the proposed actions and behaviors. In one embodiment, the actions and behaviors should respect the following requirements:
1. The representation of the actions and time-based behaviors respect the supported primitives in the MPEG-I scene description and other available formats (XML, USD).
2. The interactive space is represented with a primitive, a trigger, an action and a behavior label, which allows for interactivity between an avatar representation e.g., individual body parts or avatar area of interactive, and 3D objects in the scene.
3. Allows multiple interaction triggers with scene, objects and other avatars, and implements social, privacy and interactive bounds between any associated objects.
4. Time-based behaviors will determine the life cycle of an action and if not specifically set, the time of the event trigger and action is equal to the time duration of the 3D scene.

### Action and Behaviour in MPEG-I Scene Description

In the MPEG-I scene description we extend the existing glTF node “MPEG_scene_interactivity” element by adding the attributes described above.

Since the MPEG interactivity glTF extension allows event triggers and behaviors in the situation of collision and proximity, the proposed extension contributes with an extension of new actions and time-based attributes for behaviors/actions for a trigger in the node “MPEG_scene_interactivity”. The generic node implementation can also be applied to the avatar representation, to add interactivity and time-based constraints on the avatar and respective elements.

We propose an extension that allows glTF models to use and interact with humanoid characters (avatars) and any other objects. We propose to extend the glTF scene element “MPEG_scene_interactivity” action properties to define “ACTION_SET_AVATAR” that contains more avatar-related actions and time-based behavior constraints, as well as generic scene and node level actions.

Table 3 illustrates the new type of property added to the framework of “MPEG_scene_interactivity”.

TABLE 3
“MPEG_node_interactivity_action” extension description.

| Name | Description |
|---|---|
| “ACTION_SET AVATAR” | Get avatar-related actions on a set of nodes. Table 4 details |
| | the semantics of “ACTION_SET_AVATAR”. |

TABLE 4
Object.

| Name | Type | Usage | Description |
|---|---|---|---|
| avatarAction | object | M | Object that defines the type of avatar actions. Semantics |
| | | | are illustrated in Table 7. |

Under the new proposed “ACTION_SET_AVATAR” we have an object “avatarAction”, that represents avatar-specific actions. The semantical description is presented in Table 7. Table 5 illustrates the list of available avatar-specific actions.

TABLE 5
Types of actions.

| Action type | Description |
|---|---|
| “Action_Avatar_Social” | Set action of a node. |
| “Action_Avatar_Restricted” | Set permissions of a node. |
| “Action_Avatar_Parental” | Set parental and content usage permissions of a node. |
| “Action_Avatar_Speech” | Set speech active of a node. |

Table 6 illustrates the types of actions to be added at the scene and general node level of the interactivity framework. In the case where “ACTION_SET_AVATAR” is not available or the framework does not implement any type of avatar, the system is still capable of using the proposed action at the scene or node level.

TABLE 6
Types of actions.

| Action type | Description |
|---|---|
| “Action_Social” | Set action of a node. |
| “Action_Restricted” | Set permissions of a node. |
| “Action_Parental” | Set parental and content |
| | usage permissions of a node. |
| “Action_Speech” | Set speech active of a node. |
| “Action_Capabilities” | Set capabilities of a node. |
| “Action_Disabilities” | Set disabilities of a node. |

The semantics of the new proposed actions are provided in Table 7.

TABLE 7
Semantical description of new action properties.

| Name | Type | Usage | Description |
|---|---|---|---|
| type | string | M | Defines the type of social action (Table 2, Table |
| | | | 5, Table 6). |
| child | number | O | Index of a child action to be executed after the |
| | | | condition has been met. The default value “−1” |
| | | | means there is no child node. |
| duration | number | O | Time duration of an action in second. Default |
| | | | value is “−1” for infinite duration, greater than |
| | | | “0” to define the life of the action if is a time- |
| | | | base event otherwise is ignored. If “0” the action |
| | | | is cancelled and not executed. |
| extension | string | O | Extended attributes for any action that might not |
| | | | be included or might be application specific. |
| | | | This facilitates the content creator to extend, for |
| | | | example, the social actions or capabilities to |
| | | | other types of actions. |
| If(type == | | | |
| “Action_Social”){ | | | |
| authorised | array | M | One or more elements of Table 8 that define the |
| | | | types of social actions. |
| nodes | array | M | Indices of the nodes in the array to apply “Social |
| | | | parameters” (Table 8) listed on the “authorized” |
| | | | field. |
| } | | | |
| If(type == | | | |
| “Action_Restricted”){ | | | |
| permission_id | string | M | Unique string identifier that restricts interaction |
| | | | between nodes without an equal permission_id. |
| Nodes | array | M | Indices of the nodes in the array to apply |
| | | | “Restricted parameters”, i.e., the nodes whose |
| | | | permission IDs are to be checked/applied. |
| } | | | |
| If(type == | | | |
| “Action_Parental”){ | | | |
| age | number | M | One element of Table 9 that defines the |
| | | | minimum age recommendation for users given |
| | | | the content of the list of nodes. |
| descriptors | array | M | One or more elements of Table 10 that add |
| | | | additional explicit semantics of the content |
| | | | present in the list of nodes. |
| nodes | array | M | Indices of the nodes in the array to apply |
| | | | “Parental parameters”, e.g., as described as age |
| | | | and descriptors. |
| } | | | |
| If(type == | | | |
| “Action_Speech”){ | | | |
| microphone | Boolean | O | Indicates if the user uses a microphone type of |
| | | | input device for audio. “0” is False and “1” is |
| | | | True. The default value is 0. |
| media | String | O | URI (Uniform Resource Identifier) to media |
| | | | track to play a pre-recorder audio file. |
| nodes | array | M | Indices of the nodes in the array to allow |
| | | | “Speech” media. |
| } | | | |
| If(type == | | | |
| “Action_Capabilities”){ | | | |
| capabilities | array | M | One or more elements of Table 11 define the |
| | | | capabilities of an avatar/object. |
| nodes | array | M | Indices of the nodes in the array to apply |
| | | | “capabilities parameters”. |
| } | | | |
| If(type == | | | |
| “Action_Disabilities”){ | | | |
| disabilities | array | M | One or more elements of Table 12 that define the |
| | | | disabilities of an avatar/object. |
| nodes | array | M | Indices of the nodes in the array to apply |
| | | | “Disability parameters”. |
| } | | | |

Table 8 illustrates the types of actions when the action type is Action_Social.

TABLE 8
Type of social actions.

| Social action | Description |
|---|---|
| “conversation” | Allow social speaking with users |
| | and enable the ability for |
| | “Action_Speech” if not |
| | already enabled. |
| “interaction” | Allow interaction between users. |

Table 9 defines the minimum age recommendation for users given the content of the list of nodes.

TABLE 9
Type of age levels.

| “age” | Description |
|---|---|
| 3 | Content suitable for all ages. |
| 7 | Content with scenes or sounds |
| | possibly frightening to younger children. |
| 12 | Content with violence of graphic |
| | non-realistic characters. |
| 16 | Content with violence that mimics the reality. |
| 18 | Content designed for adults only. |

Table 10 describes additional explicit semantics of the content present in the list of nodes.

TABLE 10
Type of parental descriptors.

| Parental descriptors | Description |
|---|---|
| “violence” | Contains depiction of violence. |
| “bad_language” | Contains bad language. |
| “fear” | Contains pictures or sounds that may be frightening or scary. |
| “gambling” | Contains elements that encourage or teach gambling. |
| “sex” | Contains sexual posturing. |
| “drugs” | Contains the illustration of the use of illegal drugs, alcohol or |
| | tobacco. |
| “discrimination” | The game contains depictions of ethnic, religious, nationalistic or |
| | other stereotypes likely to encourage hatred. |
| “in-game_purchases” | Offers the option to purchase digital services. |

Table 11 defines the capabilities of an avatar/object.

TABLE 11
Capabilities semantics.

| Capabilities | Description |
|---|---|
| “walk” | The ability to walk. |
| “run” | The ability to run. |
| “jump” | The ability to jump. |
| “fly” | The ability to fly. |
| “swim” | The ability to swim. |
| “climb” | The ability to go over, get on, climb to, to descend objects, such as climb to |
| | a chair, climb up the stairs, climb down the stairs, climb the wall etc. |
| “grasp” | The ability to hold objects with hands' like representations. |
| “manipulate” | The ability to interact and change spatial position of 3D objects by using |
| | collision or proximity type of detectors. |
| “ride” | The ability to ride a vehicle or animal, such as motorcycles or horses. |
| “drive” | The ability to use a vehicle, such as cars or trucks etc. |
| “pilot” | The ability of piloting a vehicle, such as ships or airplanes. |

Table 12 defines the disabilities of an avatar/object.

TABLE 12
Disabilities semantics.

| Disabilities | Description |
|---|---|
| “Cerebral palsy” | A group of disorders that impact a person's ability to move and |
| | maintain balance. |
| “Spinal cord injuries” | Spinal cord injury indicates the damages to any part of the spinal |
| | cord or nerves at the end of the spinal canal. Result in permanent |
| | loss of strength, sensation, and function (mobility and feeling). |
| “Amputation” | Indicates removal of part of all of a body part that is enclosed by |
| | skin. |
| “Musculoskeletal | Refer to the damage of muscular or skeletal systems, which is |
| injuries” | usually due to strenuous activities. |
| “Hearing loss” | Refer to loss of hearing capabilities. This avatar will need visual |
| | cues and text replacement for speech for guidance. |
| “Vision impairment” | Refer to loss or disability with the ability to see. This avatar will |
| | mostly need audio cues for guidance. |

Table 13 illustrates the semantical description for the new behavior property (the duration of a behavior).

TABLE 13
Semantical description of new behavior properties.

| Name | Type | Usage | Description |
|---|---|---|---|
| duration | number | O | Time duration in seconds for a behavior. The default value |
| | | | is “−1” for infinite duration, greater then “0” to define the |
| | | | life of the action if is a time-base event otherwise is ignored. |

glTF Schema Examples

The following glTF is each an example of an instantiation of a “MPEG_scene_interactivity” action extension in clients that support “MPEG_scene_interactivity”. Each example illustrates a simplistic scenario supposing that the nodes or node avatars' have available the metadata to allow permission or capabilities flags.

Note that a large number of instantiations are possible, depending on the application. Here we give several examples for illustration purposes.

Example 1

```
{
  “scene”: 0,
  “nodes” : [
    {
      “mesh” : 0,
      “name” : “Box_Yellow”,
      “translation” : [
        −10,
        0,
        0
      ]
    },
    {
      “mesh” : 1,
      “name” : “Box_Red”,
      “translation” : [
        10,
        0,
        0
      ]
    },
    {
      “mesh” : 2,
      “name” : “avatar”,
      “translation” : [
        3,
        0,
        0
      ],
      “extensions”: {
        “MPEG_node_avatar”: {
          “isAvatar”: True
        }
      }
    },
  ],
  “scenes”: [
    {
      “extensions”: {
        “MPEG_scene_interactivity”: {
          “triggers”: [
            {
              “type” : “TRIGGER_PROXIMITY”,
              “distanceLowerLimit” : 0.0,
              “distanceUpperLimit” : 1.0,
              “nodes” : [0,2]
            },
            {
              “type” : “TRIGGER_PROXIMITY”,
              “distanceLowerLimit” : 0.0,
              “distanceUpperLimit” : 1.0,
              “nodes” : [1,2]
            }
          ],
          “actions”: [
            {
              “type”: “ACTION_RESTRICTED”,
              “activationStatus”: 0,
              “nodes”: [2],
              “permission_id”: “123654789”
            },
            {
              “type”: “ACTION_SOCIAL”,
              “nodes”: [2],
              “authorised”: [“conversation”, “interaction”]
            }
          ],
          “behaviors”: [
            {
              “triggers”: [0],
              “actions”: [0],
              “triggersCombinationControl”: “#1”,
              “triggersActivationControl”: “TRIGGER_ACTIVATE_FIRST_ENTER”,
              “actionsControl”: 0,
              “priority”: 1
            },
            {
              “triggers”: [1],
              “actions”: [1],
              “triggersCombinationControl”: “#1”,
              “triggersActivationControl”: “TRIGGER_ACTIVATE_FIRST_ENTER”,
              “actionsControl”: 0,
              “priority”: 1
            },
          ]
        }
      }
    }
  ]
}
```

In Example 1, there are three nodes, and the node indexed 2 with the name “avatar” represents an avatar because it has an extension “isAvatar” set to “True.”

In this example, when a node representing an avatar comes within 0.0 and 1.0 distance units of either node 0 (“Box_Yellow”) or 1 (“Box_Red”), the proximity trigger is activated and an action is performed. In this example, we illustrate two behaviors, and each example is defined in the behaviors section. Each behavior is going to link a trigger and an action. The behavior 0 verifies if the node “avatar” is in proximity with the node “Box_Yellow”. This is set by the “nodes” field in the proximity trigger (nodes: [0,2], that represent the “Box_Yellow” and “avatar” node indices), and if this condition is “True” the action with index “0” is launched. This refers to the “ACTION_RESTRICTED”, and this action is going to verify if the avatar contains the necessary permission to enter or interact with this node.

The second behavior has the exact same condition as the first one, but the trigger is on the “Box_Red”, and the action is to enable the “conversation” and “interaction” inside the box. This behavior will happen once the object first enters the pre-defined proximity. To disable action or permissions, a different behavior needs to be set.

Example 2

```
{
  “scene”: 0,
  “nodes” : [
    {
      “mesh” : 0,
      “name” : “Box_Yellow”,
      “translation” : [
        −10,
        0,
        0
      ]
    },
    {
      “mesh” : 2,
      “name” : “avatar”,
      “translation” : [
        3,
        0,
        0
      ],
      “extensions”: {
        “MPEG_node_avatar”: {
          “isAvatar”: True
        }
      }
    },
  ],
  “scenes”: [
    {
    “extensions”: {
        “MPEG_scene_interactivity”: {
          “triggers”: [
            {
              “type” : “TRIGGER_PROXIMITY”,
              “distanceLowerLimit” : 0.0,
              “distanceUpperLimit” : 1.0,
              “nodes” : [0,1]
            }
          ],
          “actions”: [
            {
              “type”: “ACTION_PARENTAL”,
              “activationStatus”: 0,
              “nodes”: [1],
              “age”: 3,
              “Descriptors”: [“in-game_purchases”]
            }
          ],
          “behaviors”: [
            {
              “triggers”: [0],
              “actions”: [0],
              “triggersCombinationControl”: “#1”,
              “triggersActivationControl”: “TRIGGER_ACTIVATE_FIRST_ENTER”,
              “actionsControl”: 0,
              “priority”: 1
            }
          ]
        }
      }
    }
  ]
}
```

In Example 2, there are two nodes, and the node indexed 1 with the name “avatar” represents an avatar. The authorization and control of each node should be handled on the engine side and not on the scene description side. When a node representing an avatar comes within 0.0 and 1.0 distance units of node 0 (“Box_Yellow”), the proximity trigger is activated and an action is performed.

In this scenario, we illustrate one example that defines a single behavior. The behavior is going to link a trigger and an action. The behavior 0 verifies if the node “avatar” is in proximity with the node “Box_Yellow”. This is set by the “nodes” field in the proximity trigger (nodes: [0,1], that represent the “Box_Yellow” and “avatar” node indices), and if this condition is “True” the action with index “0” is launched. This refers to the “ACTION_PARENTAL”, and this action is going to signal the user of the type of content and the minimum age required to verify if the avatar contains the necessary permission to enter or interact with this node.

This behavior will happen once the object first enters the proximity. To disable action or permissions, a different behavior needs to be set.

Example 3

```
{
  “scene”: 0,
  “nodes” : [
    {
      “mesh” : 0,
      “name” : “Box_Yellow”,
      “translation” : [
        −10,
        0,
        0
      ]
    },
    {
      “mesh” : 2,
      “name” : “avatar”,
      “translation” : [
        3,
        0,
        0
      ],
      “extensions”: {
        “MPEG_node_avatar”: {
          “isAvatar”: True
        }
      }
    },
  ],
  “scenes”: [
    {
      “extensions”: {
        “MPEG_scene_interactivity”: {
          “triggers”: [
            {
              “type” : “TRIGGER_PROXIMITY”,
              “distanceLowerLimit” : 0.0,
              “distanceUpperLimit” : 1.0,
              “nodes” : [0,1]
            }
          ],
          “actions”: [
            {
              “type”: “ACTION_SPEECH”,
              “activationStatus”: 0,
              “nodes”: [1],
              “microphone”: “True”,
              “duration”: 180
            }
          ],
          “behaviors”: [
            {
              “triggers”: [0],
              “actions”: [0],
              “triggersCombinationControl”: “#1”,
              “triggersActivationControl”: “TRIGGER_ACTIVATE_FIRST_ENTER”,
              “actionsControl”: 0,
              “priority”: 1
            }
          ]
        }
      }
    }
  ]
}
```

In Example 3, there are two nodes, and the node indexed 1 with the name “avatar” represents an avatar. The authorization and control of each node should be handled on the engine side and not on the scene description side. When a node representing an avatar comes within 0.0 and 1.0 distance units of the node 0 (“Box_Yellow”), the proximity trigger is activated and an action is performed.

In this scenario, we illustrate one example that defines a single behavior. The behavior is going to link a trigger and an action. The behavior 0 verifies if the node “avatar” is in proximity with the node “Box_Yellow”. This is set by the “nodes” field in the proximity trigger (nodes: [0,1], that represent the “Box_Yellow” and “avatar” node indices), and if this condition is “True” the action with index “0” is launched. This refers to the “ACTION_SPEECH”, and this action is going to signal the application that this node avatar can use the microphone for a duration of 180 seconds.

Example 4

```
{
  “scene”: 0,
  “nodes” : [
    {
      “mesh” : 0,
      “name” : “Box_Yellow”,
      “translation” : [
        −10,
        0,
        0
      ]
    },
    {
      “mesh” : 2,
      “name” : “avatar”,
      “translation” : [
        3,
        0,
        0
      ],
      “extensions”: {
        “MPEG_node_avatar”: {
          “isAvatar”: True
        }
      }
    },
  ],
  “scenes”: [
    {
      “extensions”: {
        “MPEG_scene_interactivity”: {
          “triggers”: [
            {
              “type” : “TRIGGER_PROXIMITY”,
              “distanceLowerLimit” : 0.0,
              “distanceUpperLimit” : 0.0,
              “nodes” : [0,1]
            }
          ],
          “actions”: [
            {
              “type”: “ACTION_CAPABILITIES”,
              “activationStatus”: 0,
              “nodes”: [1],
              “capabilities”: [“climb”,“ride”,“fly”],
              “duration”: 240
            },
          ],
          “behaviors”: [
            {
              “triggers”: [0],
              “actions”: [0],
              “triggersCombinationControl”: “#1”,
              “triggersActivationControl”: “TRIGGER_ACTIVATE_FIRST_ENTER”,
              “actionsControl”: 0,
              “priority”: 1
            },
          ]
        }
      }
    }
  ]
}
```

Example 4 is similar to Example 3. The difference is that the actions for the nodes are triggered based on contact (lower limit=upper limit=0.0). In addition, in the “ACTION CAPABILITIES”, it sets new capabilities for the avatar (to climb, ride and fly) when the proximity trigger is activated for a duration of 240 seconds (instead of 180 seconds in Example 3).

Example 5

```
{
  “scene”: 0,
  “nodes” : [
    {
      “mesh” : 0,
      “name” : “Box_Yellow”,
      “translation” : [
        −10,
        0,
        0
      ]
    },
    {
      “mesh” : 2,
      “name” : “avatar”,
      “translation” : [
        3,
        0,
        0
      ],
      “extensions”: {
        “MPEG_node_avatar”: {
          “isAvatar”: True
        }
      }
    },
  ],
  “scenes”: [
    {
      “extensions”: {
        “MPEG_scene_interactivity”: {
          “triggers”: [
            {
              “type” : “TRIGGER_PROXIMITY”,
              “distanceLowerLimit” : 0.0,
              “distanceUpperLimit” : 1.0,
              “nodes” : [0,1]
            }
          ],
          “actions”: [
            {
              “type”: “ACTION_DISABILITIES”,
              “activationStatus”: 0,
              “nodes”: [1],
              “disabilities”: [“Hearing loss”]
            },
          ],
          “behaviors”: [
            {
              “triggers”: [0],
              “actions”: [0],
              “triggersCombinationControl”: “#1”,
              “triggersActivationControl”: “TRIGGER_ACTIVATE_FIRST_ENTER”,
              “actionsControl”: 0,
              “priority”: 1
            },
          ]
        }
      }
    }
  ]
}
```

Example 5 is similar to Example 4. The difference is that in the “ACTION_DISABILITIES”, it signals the disabilities available on the “Box_Yellow”, which notifies the users that the interactivity with this region will take into consideration “Hearing_loss” and display the appropriated visual cues.

Example 6

```
{
  “scene”: 0,
  “nodes” : [
    {
      “mesh” : 0,
      “name” : “Box_Yellow”,
      “translation” : [
        −10,
        0,
        0
      ]
    },
    {
      “mesh” : 2,
      “name” : “avatar”,
      “translation” : [
        3,
        0,
        0
      ],
      “extensions”: {
        “MPEG_node_avatar”: {
          “isAvatar”: True
        }
      }
    },
  ],
  “scenes”: [
    {
      “extensions”: {
        “MPEG_scene_interactivity”: {
          “triggers”: [
            {
              “type” : “TRIGGER_PROXIMITY”,
              “distanceLowerLimit” : 0.0,
              “distanceUpperLimit” : 1.0,
              “nodes” : [0,1]
            }
          ],
          “actions”: [
            {
              “type”: “ACTION_SET_AVATAR”,
              “activationStatus”: 0,
              “avatarAction”: {
                “type”: “ACTION_AVATAR_DISABILITIES”,
                “nodes”: [1],
                “disabilities”: [“Hearing loss”]
              }
            }
          ],
          “behaviors”: [
            {
              “triggers”: [0],
              “actions”: [0],
              “triggersCombinationControl”: “#1”,
              “triggersActivationControl”: “TRIGGER_ACTIVATE_FIRST_ENTER”,
              “actionsControl”: 0,
              “priority”: 1
            },
          ]
        }
      }
    }
  ]
}
```

Example 6 is similar to Example 5. The difference is in the use of “ACTION_SET_AVATAR” to specify the “ACTION_AVATAR DISABILITIES”. Signaling of “ACTION_SET_AVATAR” indicates that node 1 is an avatar node and the action is an avatar-specific one (Disability). Specifically, it signals the disabilities available in the “Box_Yellow”, which notifies the users that the interactivity with this region will take into consideration “Hearing_loss” and display the appropriated visual cues.

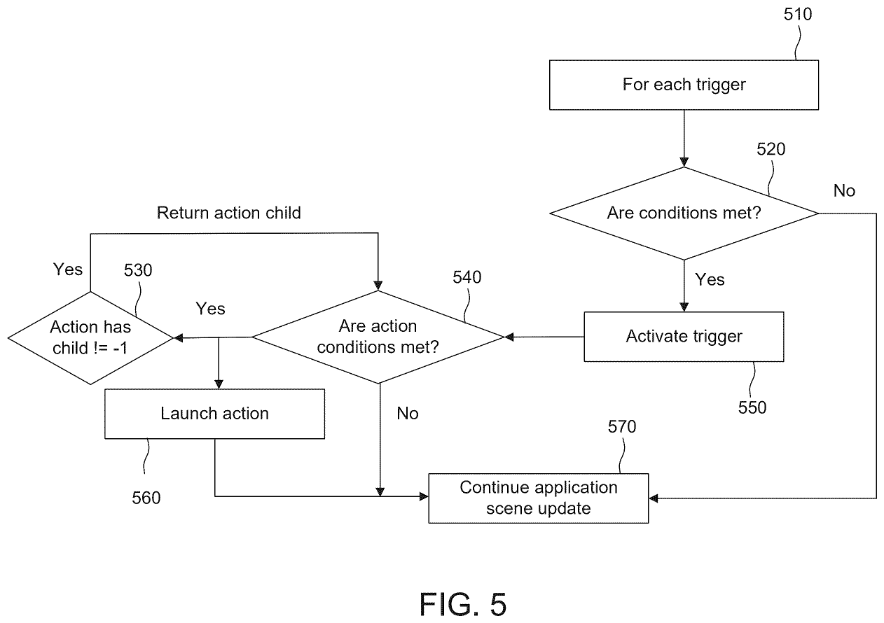

FIG. 5 illustrates an example of the execution of a hierarchical action, according to an embodiment. This example illustrates how actions can affect the activation of consequent actions. As illustrated in FIG. 5, for each trigger (510), we evaluate (520) if the conditions of trigger activation (e.g., proximity) are met at each scene update. If the condition trigger does not fulfill the conditions, the processing model continues to the next scene update without changes to the trigger or activating the actions. On the other hand, if the trigger conditions are met the trigger is activated (550) and the action is launched (560) if the action conditions (e.g., permission) are satisfied (540). Once the action is launched (560), we evaluate if the action has children's actions (530), if so, they are also evaluated (540) and launched (560) if the conditions are satisfied. Once all actions and their dependent children's actions are launched (560) the application continues to the next scene update (570).

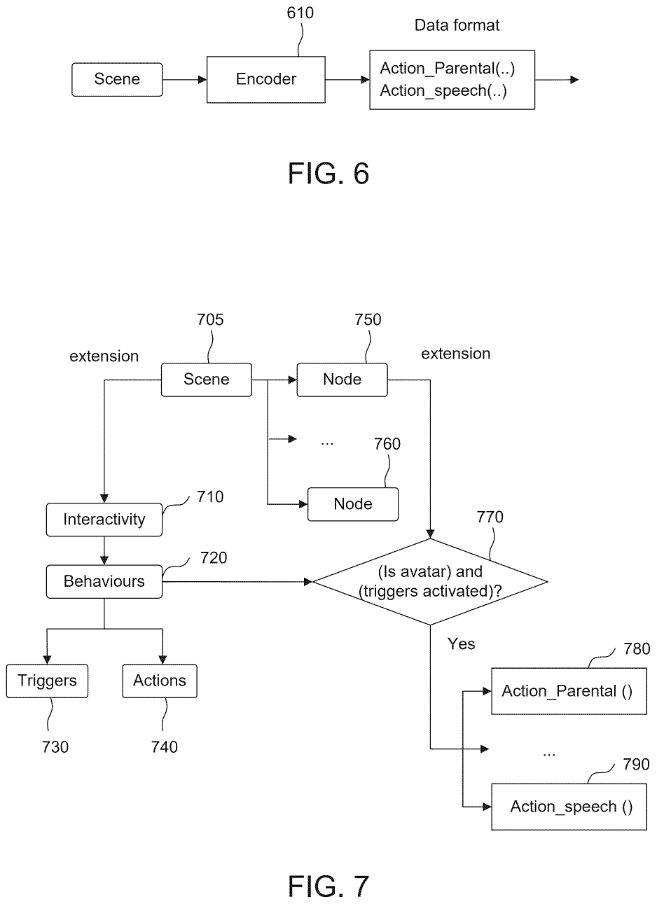

FIG. 6 illustrates the generation of parameters with scene encoding by an encoder (610), which uses a scene description file format as input, and outputs and encoded data format representative of the scene. In particular, FIG. 7 illustrates the diagram of encoding for the encoder, according to an embodiment. In particular, for the extended node “Interactivity” (710) of the “Scene” node (705), there are “Behaviours” (720) defining links between “Triggers” (730) and “Actions” (740). These “Actions” (740) are encoded (1) if a “Node” node (750, 760) is seen as an avatar (e.g., using the extended “is_avatar” attribute) and (2) if the triggers are activated by the avatar (770). As a result, the parameters, e.g., “Action_Parental( )” (780) and “Action_Speech( )” (790) are generated.

Various numeric values are used in the present application. The specific values are for example purposes and the aspects described are not limited to these specific values.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method, comprising:
obtaining, from a scene description for an extended reality scene, at least a parameter used to define one or more permitted actions for an avatar node representing an avatar;
activating a trigger to an action associated with said avatar node, wherein said action belongs to said one or more permitted actions; and
launching said action for said avatar node.

2-4. (canceled)

5. The method of claim 1, wherein said one or more permitted actions include at least one of the following types:
setting action of said avatar node,
setting restrictions of said avatar node,
setting parental and content usage permissions of said avatar node,
setting permitted speech activity of said avatar node,
setting capabilities of said avatar node, and
setting disabilities of said avatar node.

6. The method of claim 1, wherein said at least a parameter indicates capabilities of said avatar.

7. The method of claim 6, or the apparatus of claim 6, wherein said capabilities include at least one of the following:
the ability to walk,
the ability to run,
the ability to jump,
the ability to fly,
the ability to swim,
the ability to go over, get on, climb to, to descend objects,
the ability to hold objects with hands like representations,
the ability to interact and change spatial position of 3D objects by using collision or proximity type of detectors,
the ability to ride a vehicle or animal,
the ability to use a vehicle, and
the ability of piloting a vehicle.

8. The method of claim 1, wherein said at least a parameter indicates disabilities of said avatar.

9-11. (canceled)

12. The method of claim 1, wherein said at least a parameter indicates a content type of a list of nodes.

13-14. (canceled)

15. A method, comprising:
generating at least a parameter in a scene description for an extended reality scene to define one or more permitted actions for an avatar node representing an avatar;
associating a trigger to an action with said avatar node, wherein said action belongs to said one or more permitted actions; and
encoding said scene description for said extended reality scene.

16. The method of claim 15, wherein said one or more permitted actions include at least one of the following types:
setting action of said avatar node,
setting restrictions of said avatar node,
setting parental and content usage permissions of said avatar node,
setting permitted speech activity of said avatar node,
setting capabilities of said avatar node, and
setting disabilities of said avatar node.

17. The method of claim 15, wherein said at least a parameter indicates capabilities of said avatar.

18. The method of claim 15, wherein said at least a parameter indicates disabilities of said avatar.

19. An apparatus, comprising one or more processors and at least one memory, wherein said one or more processors are configured to:
obtain, from a scene description for an extended reality scene, at least a parameter used to define one or more permitted actions for an avatar node representing an avatar;
activate a trigger to an action associated with said avatar node, wherein said action belongs to said one or more permitted actions; and
launch said action for said avatar node.

20. The apparatus of claim 19, wherein said one or more permitted actions include at least one of the following types:
setting action of said avatar node,
setting restrictions of said avatar node,
setting parental and content usage permissions of said avatar node,
setting permitted speech activity of said avatar node,
setting capabilities of said avatar node, and
setting disabilities of said avatar node.

21. The apparatus of claim 19, wherein said at least a parameter indicates capabilities of said avatar.

22. The apparatus of claim 19, wherein said capabilities include at least one of the following:
the ability to walk,
the ability to run,
the ability to jump,
the ability to fly,
the ability to swim,
the ability to go over, get on, climb to, to descend objects,
the ability to hold objects with hands like representations,
the ability to interact and change spatial position of 3D objects by using collision or proximity type of detectors,
the ability to ride a vehicle or animal,
the ability to use a vehicle, and
the ability of piloting a vehicle.

23. The apparatus of claim 19, wherein said at least a parameter indicates disabilities of said avatar.

24. The apparatus of claim 19, wherein said at least a parameter indicates a content type of a list of nodes.

25. An apparatus, comprising one or more processors and at least one memory, wherein said one or more processors are configured to:
generate at least a parameter in a scene description for an extended reality scene to define one or more permitted actions for an avatar node representing an avatar;
associate a trigger to an action with said avatar node, wherein said action belongs to said one or more permitted actions; and
encode said scene description for said extended reality scene.

26. The apparatus of claim 25, wherein said one or more permitted actions include at least one of the following types:
setting action of said avatar node,
setting restrictions of said avatar node,
setting parental and content usage permissions of said avatar node,
setting permitted speech activity of said avatar node,
setting capabilities of said avatar node, and
setting disabilities of said avatar node.

27. The apparatus of claim 25, wherein said at least a parameter indicates capabilities of said avatar.

28. The apparatus of claim 25, wherein said at least a parameter indicates disabilities of said avatar.

29. The apparatus of claim 25, wherein said at least a parameter indicates a content type of a list of nodes.
